(19) United States
(12) Patent Application Publication
(10) Pub. No.: US 2020/0039417 A1
(43) Pub. Date: Feb. 6, 2020

(54) Magnetic Cargo Strap

(71) Applicant: Ronald S. Dankert, Truth or Consequences, NM (US)

(72) Inventor: Ronald S. Dankert, Truth or Consequences, NM (US)

(21) Appl. No.: 16/054,421

(22) Filed: Aug. 3, 2018

(51) Int. Cl. B60P 7/08; B66C 1/14

(52) U.S. Cl. CPC B60P 7/0823; B66C 1/14

(57) ABSTRACT

A cargo containment system with a first leg, a strap retaining void within the first leg, a magnet retaining void space carrying a magnet within the first leg.

### BACKGROUND OF THE INVENTION

This invention relates to a cargo containment systems and improvements to associated components, such as ratchet straps strap hooks. The invention is particularly suited for situations where it is desirable to secure a carried load, for instance (but not limited to) in a bed of a truck.

### SUMMARY OF THE INVENTION

A magnetized strap and hook system for cargo containment is disclosed. An anchor strap is provided,

A strap is coupled to a hook, just as a J-hook structure. The J-hook structure carries an embedded magnet, which conveniently assists users in load securement.

A hook is disclosed comprising a first leg, a strap retaining void within said first leg, a magnet retaining void space within said first leg, a magnet carried within said magnet retaining void, a curved portion between said first leg and a second leg. In an alternate embodiment, said magnet retaining void space further comprises a hole through said first leg, and a backing structure coupled to said first leg, said backing structure carrying said magnet. The hook carries a strap through said strap retaining void. The hook can be formed from a plate or a wire. The magnet retaining void space can be within at least one of said first and second legs, said magnet retaining void space comprising a height and a width, a magnet carried within said magnet retaining void, said magnet comprising a height and a width, the height of said magnet smaller than the height of said magnet retaining void space.

### BRIEF DESCRIPTION OF THE DRAWINGS

FIG. 1 perspective, in-use view of a strap and a J-hook of the present invention securing a load carried by a truck;

FIG. 2 is a side perspective view of a J-hook present invention;

FIG. 3 is a front view of a J-hook of the present invention;

FIG. 4 is a side cross-sectional view of a J-hook of the present invention;

FIG. 4A is a side cross-sectional view of an alternate embodiment of a J-hook of the present invention;

FIG. 5 is a side in-use view of a J-hook of the present invention;

FIG. 6 is a perspective view of an alternate embodiment of a J-hook of the present invention;

FIG. 7 is a perspective view of an additional alternate embodiment of a J-hook of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

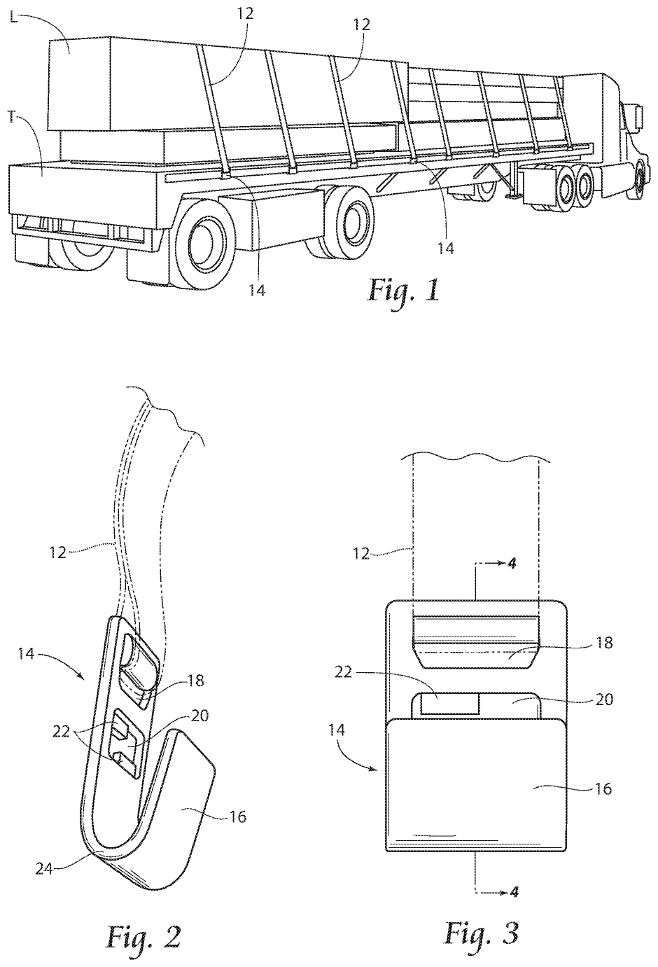

Referring now to FIG. 1, a rear perspective, in-use view of a series of straps 12 carrying J-hooks 14 of the present invention is shown securing a load L, carried for exemplary purposes in a bed of a truck T. A series of anchor straps 12 are provided about the bed of truck T, secured preferably to anchors 30 commonly present in truck beds T (see FIG. 5 for the anchors 30, which can be for instance a rail.

In a preferred embodiment, referring now to FIGS. 2 and 3, anchor straps 12 are coupled to a J-Hook 14 by a strap void structure 18 near a first end of the J-Hook 14. The J-Hook 14 has a preferably structurally strong J-structure 24, and at a second end has a rail engaging portion 16. A magnet void 20 is provided preferably on a main straight leg of the J-Hook 14 structure, although it could alternatively be supplied on the engaging portion 16. Embedded in the magnet void 20 is a magnet 22 or multiple magnets 22.

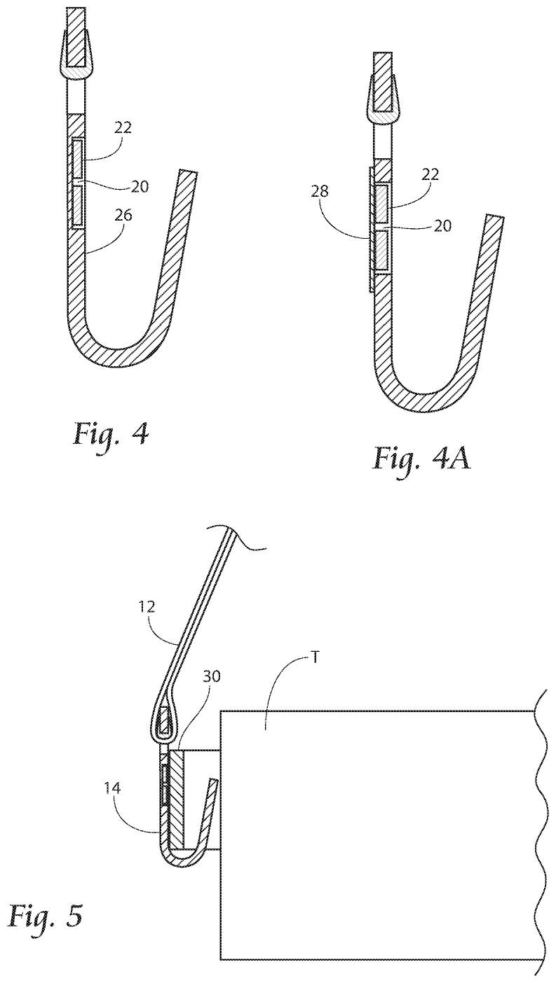

Referring now to FIG. 4, a side cross-sectional view of a J-hook 14 of the present invention is shown. Magnet void 20 is seen carrying magnet or magnets 22. In a preferred embodiment, the magnets 22 are either equal to or slightly shorter than a depth of the void 20, such that the main leg portion of the J-Hook 14 structure 24, such that magnets 22 do not interfere with tight load securement once the straps 12 are tightened during use. In other words, an inner surface of the J-hook main leg 26 is at or above a contacting level of magnet(2) 22.

Referring now to FIG. 4A, an alternate embodiment of a J-hook 14 of the present invention is shown. In this embodiment, void 20 is provided through the main leg of the J-hook structure 24. In this embodiment, prior to installation of magnet(s) 22, a backing plate 28 is provided on an outward facing portion of the J-hook main leg 26.

Referring now to FIG. 5, a side in-use view of a J-hook 14 of the present invention is shown. Truck T preferably carries a hook retaining structure 30, such as rail, but this structure could also be a hook or void space on a truck T, the truck T merely forming an environment which the J-hook 14 is to be used. In use, magnets 22 of the J-hook 14 provide a coupling force to hook retaining structure 30, which assists users in attaching the J-hook 14 while the strap 12 is secured about a load L (see FIG. 1).

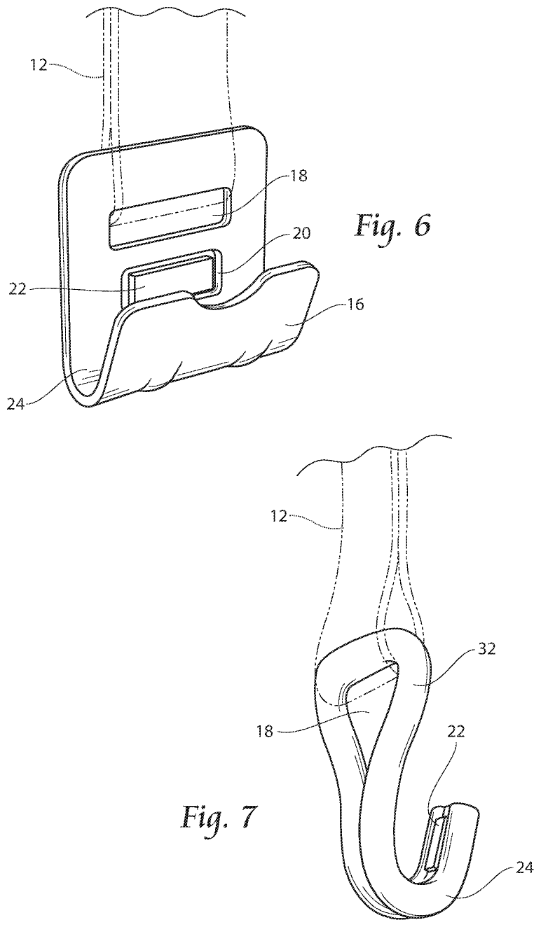

Referring now to FIG. 6, a perspective view of an alternate embodiment of a J-hook 14 of the present invention is show. In this embodiment, a single magnet 22 is shown in void 20. Also in this embodiment, engaging portion 16 can be notched as shown.

Referring now to FIG. 7, a perspective view of an additional alternate embodiment of a J-hook of the present invention is shown. In this embodiment, a J-wire 32 is provided to form preferably a J-shape. In this embodiment, a single strand of wire is bent as shown, with a first end and a second end of the wire 32 closely coupled, and a midsection forming a strap retaining loop 18. A magnet 22 is embedded at the intersection of the first and second ends of wire 32, or could be provided between other portions of the wire 32, for instance in the long leg of the J as shown with regard to FIGS. 1-6.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A hook comprising:
a first leg comprising a back surface and a front surface defining a leg thickness,
a strap retaining void within said first leg,
a recessed magnet retaining void space within said first leg between said back surface and said front surface,
a magnet carried within said recessed magnet retaining void space said magnet recessed between said back surface and said front surface, said magnet comprising a height less than said leg thickness, said magnet positioned between said back surface and said front surface,
a curved portion between said first leg and a second leg.

2. The hook of claim 1, said recessed magnet retaining void space further comprising a hole through said back surface and said front surface of said first leg, and a backing structure coupled to said first leg, said backing structure carrying said magnet.

3. The hook of claim 1, the hook carrying a strap through said strap retaining void.

4. The hook of claim 1, said first leg, said curved portion and said second leg formed from a plate.

5. The hook of claim 1, said first leg, said curved portion and said second leg formed from a bent wire.

6. A hook comprising:
a first leg comprising an inner and an outer surface,
a second leg comprising an inner and an outer surface, said second leg coupled to said first leg by a curved surface,
a strap retaining void within said first leg,
a recessed magnet retaining void space within at least one of said first and second legs, said recessed magnet retaining void space comprising a height and a width,
a recessed magnet carried within said recessed magnet retaining void, said recessed magnet comprising a height and a width,
a height of said recessed magnet smaller than the height of said recessed magnet retaining void space.

7. The hook of claim 6, said first leg, said curved portion and said second leg formed from a plate.

8. The hook of claim 6, said first leg, said curved portion and said second leg formed from a bent wire.

9. A hook comprising:
a wire comprising two free ends and a midsection;
said two free ends coupled to form a short leg,
said midsection curved to for a strap retaining structure;
a magnet embedded within said short leg.
